(19) United States
(12) Patent Application Publication
(10) Pub. No.: US 2008/0279506 A1
(43) Pub. Date: Nov. 13, 2008

(54) Blown Optical Fibre Multi-Tube Terminal Connectors

(76) Inventors: John Kerry, Ipswich (GB); Matthew John Kerry, Ipswich (GB); Rosamund Carol Neat, Hertfordshire (GB)

Correspondence Address: Sue Z Shaper, 1800 West Loop South, Suite 1450, Houston, TX, 77027, US

(21) Appl. No.: 11/793,951

(22) PCT Filed: Dec. 22, 2005
(86) PCT No.: PCT/GB2005/005004

§ 371 Date: Feb. 12, 2008

(30) Foreign Application Priority Data
Dec. 22, 2004 (GB) 0428053.3

(51) Int. Cl. G02B 6/38

(52) U.S. Cl. 385/59

(57) ABSTRACT

A multi-tube terminal connector for connecting tubes into which optical fibres are to be installed by the blown fibre technique, comprising a first part (4) arranged to receive and fit onto a cable (1) of closely packed tubes, and a spreader (5) provided with guideways to splay the tubes received by the first part from their initially closely packed state to a spaced relationship where the spacing is greater than the spacing at the initially closely packed state, the arrangement being such that provision (3) is made so as to connect the connector to at least one further element.

### FIELD OF THE INVENTION

This invention relates to connectors, and specifically to terminal connectors for tubes for carrying optical fibre.

### BACKGROUND OF THE INVENTION

Fibre optic cables are used in the communications industry for transmitting information by light through the individual fibres. During installation, in a method known as the blown fibre method, the fibres or cabled fibres are blown along lengths of tube. Bundles of blown fibre tubes can be arranged in a cable or outer duct. This technique is described in EP0408266A2 (BICC & Corning) and EP0345043 (British Telecommunications).

Tubes to carry optical fibres normally need to be connected, e.g. to further lengths of fibre optic tubes, or to a terminal device. A connector for this purpose is disclosed in co-pending application, “Optical Fibre Multi-Tube Connector”, as illustrated in FIG. 1. However, the proposal illustrated in this application may suffer from problems on assembly of the tubes into the connector. As can be seen in FIG. 1, after each layer of tubes has entered a separate circular channel in the alignment device, the individual tubes must enter a particular hole within the channel. This would be difficult to achieve on assembly.

The connector described in the co-pending application affords only a limited degree of flexibility in relation to future upgrade or reconfiguration of an in-line joint, as only one connector locking ring is provided with this configuration.

The connector disclosed in the above co-pending application may also suffer from problems in gripping the cable it is connecting, as it can be difficult to obtain the necessary gripping force with the gland slip ring, as illustrated in FIG. 1.

A further configuration of the connector may be in the form of a gland system. An optical fibre multi-tube gland system would provide certain advantages over the embodiments described above. The gland system enables the joining and configuration of two or more multi-tube cables without disruption to circuits running over existing optical fibres contained in tubes from the initial joint. Extra material for resealing, and special tools, e.g. for heat shrinking, would not be required.

The gland system would also have significant space-saving advantages over current multi-tube cable joint systems. Currently, multi-tube cable joints can be enclosed by a ‘box’ comprising a base, sides, and a cover which is removable to allow access. As manual access to the joint will often be required for maintenance, e.g. re-routing and configuration, the enclosure must be sufficiently large to allow an engineer to access each individual tube and connector, and sufficient space for manoeuvrability without kinking the tubes by subjecting them to bends above their minimum bend radius (discussed later). The gland system reduces the space requirement in enclosures by using a chassis to retain the multi-tube cable, and using a two-part removable enclosure to cover the joint.

A further advantage of the gland system is produced by the use of patch tubes within the enclosure. Currently, individual tubes from the two multi-tube cables are connected using a single straight tube connector per tube, which is usually positioned in the centre of the enclosure to provide maximum tube handling space either side of the connector. This results in a joint which is considerably larger in diameter than the cables which are being joined. For example, a nineteen tube cable, which would be approximately 28 mm in diameter, would require nineteen single connectors, thus forming a minimum circular configuration of approximately 60 mm diameter. Care must also be taken not to over-bend the tubes between the cable butt and the connectors.

### SUMMARY OF THE INVENTION

Accordingly, the present invention provides a blown optical fibre multi-tube terminal connector comprising a first part arranged to receive and clamp onto a cable of tubes in an initially closely packed state, and a spreader provided with guideways to splay the tubes received by the first part from an initially closely packed state to a spaced relationship where the spacing is greater than the spacing at the initially closely packed state, the arrangement being such that provision is made so as to connect the connector to at least one further element.

When a further cable is added to the join and reconfiguration is necessary, there may be an insufficient length of tube available to make the join to the new cable; a further single connector may be required. It is usual, to aid the installation process, for connectors to be placed on a straight section of tube rather than directly on a bend.

The present invention overcomes these problems by using a multi-tube connector module; a range of capabilities will match the tube count of the multi-tube cable. Furthermore, two of these multi-tube connector modules will be used between the two multi-tube cables, each multi-tube cable will be terminated into its own module and will be located close to the cable butt. The connection made between the two multi-tube cables is achieved by linking the two multi-tube connector modules with single patch tubes. The space required between the two multi-tube connectors to avoid the over-bending of the tube is approximately half that of the conventional method even when the extra length of the second connector is taken into account, thus further reducing the space requirements. Because only a small length of patch tube is required, e.g. it does not run the entire length of the multi-tube cable, these tubes may be constructed of a material with bend restricting capabilities which may be more expensive that the conventional tube.

In the radial plane, the nineteen-way multi-tube connector module is significantly smaller than nineteen single connectors and reduces the severity of the bends in tubes, between the cable butt and the multi-tube connector module and in addition these bends are managed at all times other than when a bend restricting material is used.

The gland system comprising a two-part removable enclosure would allow 360° access to the individual tubes,

The gland system could also be used to secure a multi-tube cable at a termination point, either a bulkhead or other similar structure.

In all cases the gland system provides for gas blocking of multi-tube cable interstices as required. Gas blocking is often required at an internal/external cable interface to block the gas path in the tube interstices of a multi-tube cable.

### BRIEF DESCRIPTION OF DRAWINGS

Reference will now be made to embodiments of the invention by way of example to the accompanying drawings.

FIG. 1 is a fully expanded perspective view of a pair of blown optical fibre multi-tube connectors as disclosed in co-pending patent application “Optical Fibre Multi-Tube Connector”.

FIG. 2 is a perspective view of a pair of fully assembled blown optical fibre multi-tube connectors in accordance with the present invention.

FIG. 3 is a perspective view of all components of a pair of blown optical fibre multi-tube connector in accordance with the present invention.

FIG. 3a is a perspective view of the cable gripping gland of the blown optical fibre multi-tube connector in accordance with the present invention.

FIG. 3b is a side elevation of the spreader of the blown optical fibre multi-tube connector in accordance with the present invention.

FIG. 4 is a longitudinal cross section (along the line A-A of FIG. 2) of a pair of blown optical fibre multi-tube connectors in accordance with the present invention.

FIG. 4a is a formulaic representation of the displacement of the tube from its original position and for the subsequent distance between the beginning and end of the bend in the connector.

FIG. 5 is a longitudinal cross section of an ‘elbow’ connector of the blown optical fibre multi-tube connector in accordance with the present invention.

FIG. B1 is a perspective view of the optical fibre multi-tube gland system.

FIG. B2 is a partially expanded perspective view of the optical fibre multi-tube gland system.

FIG. B3 is a fully expanded perspective view of the optical fibre multi-tube gland system.

FIG. B4 is longitudinal cross section of the optical fibre multi-tube gland system.

FIG. B5 is a perspective view of a patch tube interface assembly, and cross sections of one version of patch tube interface assembly in an open and closed state.

FIG. B6 is a perspective view of the optical fibre multi-tube gland system being used to enable insertion of a gas blocking material.

FIG. B7 is a side view of the optical fibre multi-tube gland system, chassis and enclosure.

FIG. B8 is a plan view of a multi-tube configuration for a cable joined in an enclosure.

FIG. B9 is a plan view of the optical fibre multi-tube gland system and chassis and possible chassis extension to form a T′ configuration.

FIGS. B10a, B10b and B10c show alternative versions of the optical fibre multi-tube gland system allowing route flexibility with different chassis arrangements.

### DETAILED DESCRIPTION OF PREFERRED EMBODIMENTS

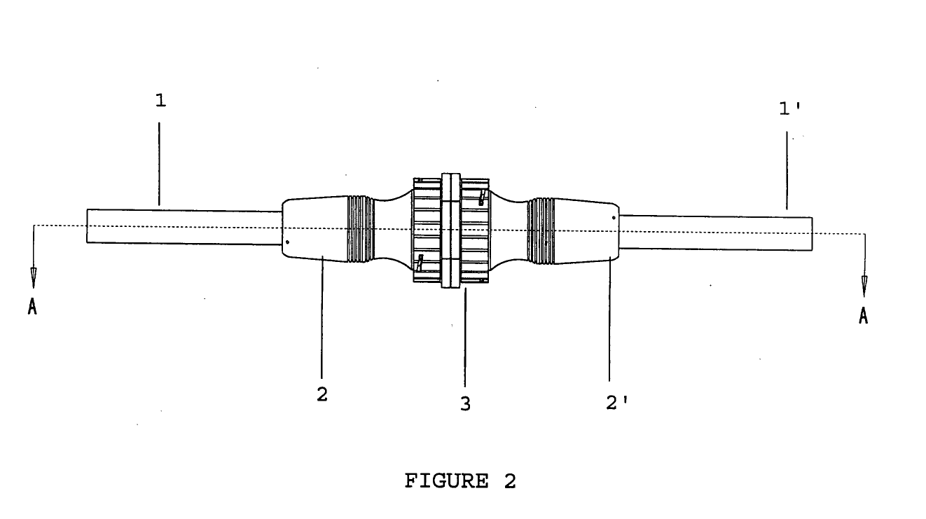

FIG. 2 shows a cable of tubes 1 terminating in connector 2, and second cable of tubes 1′ terminating in connector 2′. Connecting part 3 links the two connectors thereby joining the cables.

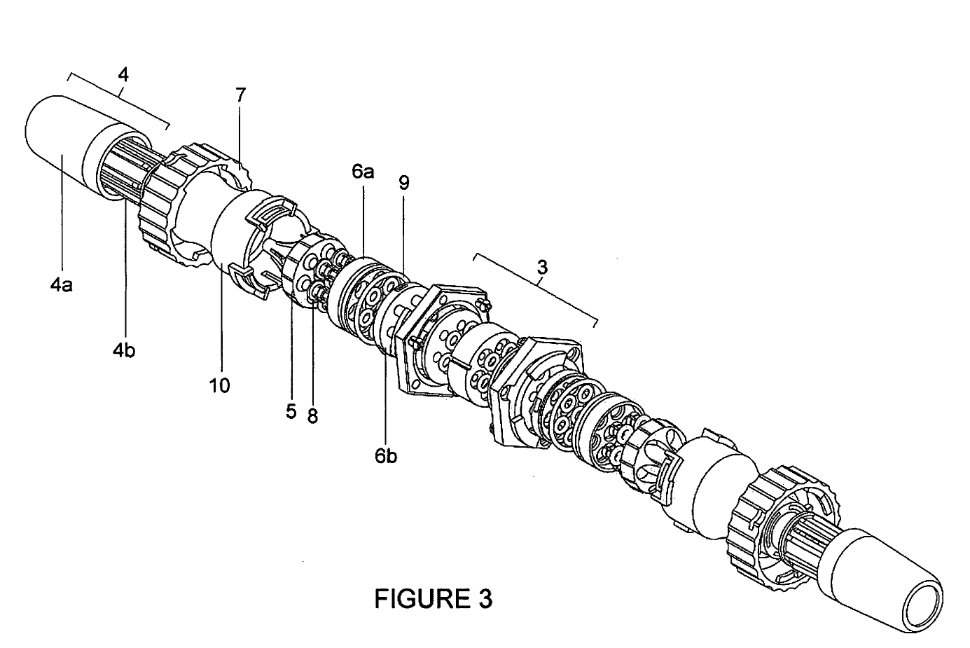

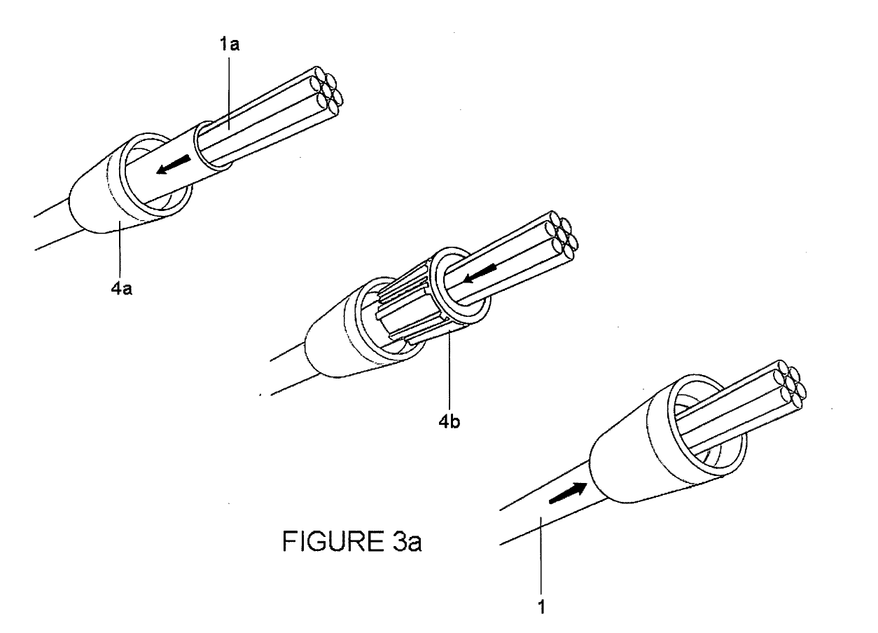

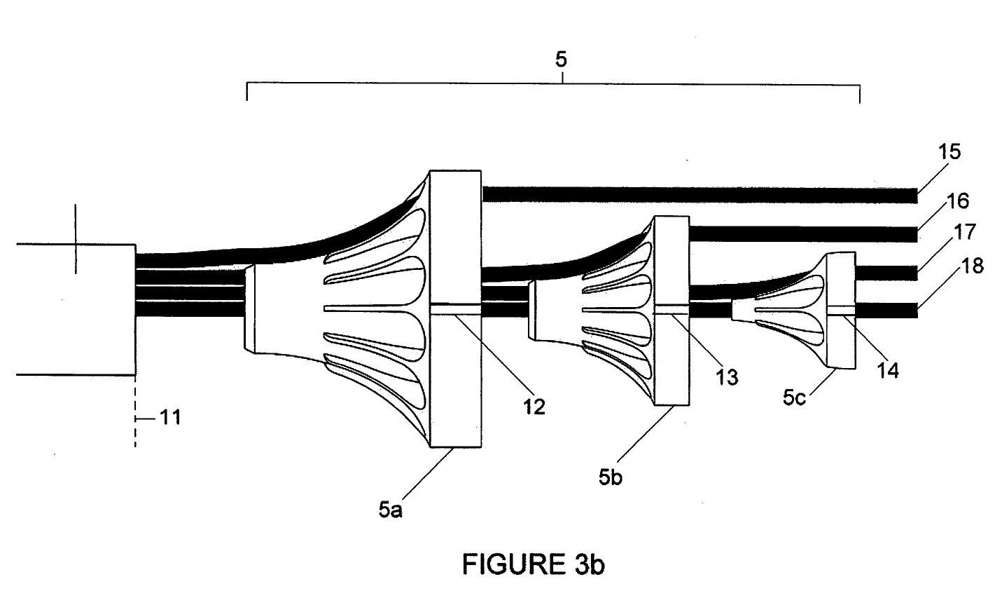

FIG. 3 illustrates the separated components of the connector, and the connecting part. The connector comprises a first part for receiving and clamping onto a cable of tubes (comprising gland body 4a and cable adapter 4b), a spreader 5, and a connecting part 3.

Cable gripping gland 4 clamps onto a cable of tubes 1 (as shown in FIG. 3a). The tubes are then separated by spreader 5 (as shown in FIG. 3b). Spreader 5 guides each tube into a channel to align with a particular channel in tube seating body 6a. The separated tubes then pass through individual channels in tube seating body 6a. The channels of the tube seating body 6a decrease in diameter at a point such that a shoulder is formed on which the terminal ends of the tubes sit.

Tube seating body 6a and male plug 6b interface with connecting part 3. This arrangement ensures that each tube is connected sealingly to the next inline tube via tube seating body 6a and connecting part 3. A sealing means 8 is provided between the spreader 5 and tube seating body 6a, and between male plug 6b and connecting part 3. The connecting part 3 links one connector to another, or to a device. The connection is made secure by connector locking ring 7. Once assembled, connector shell 10 houses spreader 5, sealing means 8, tube seating body 6a, male plug 6b, and sealing means 9.

As illustrated in FIG. 3a, cable gripping gland 4 comprises gland body 4a and cable adapter 4b. In operation, gland body 4a is pushed over cable of tubes 1, cable adapter 4b is pushed over the exposed tubes 1a and onto the sheath up to cable sheath butt 11, gland body 4a is then moved over cable adapter 4b until a tight fit is achieved.

A significant advantage provided by the design of cable gripping gland 4 is that the greater the pulling force on cable of tubes 1 in a direction towards cable adapter 4b, the tighter the grip between cable adapter 4b and cable of tubes 1 (up to a point of failure).

The spreader 5 is shown in greater detail in FIG. 3b. This figure illustrates a three part spreader to be used for a thirty-one tube cable comprising four layers of tubes. One tube of each layer is illustrated in the figure (tube 15 for the outer tube layer, tube 16 for the intermediate tube layer, tube 17 for the inner tube layer, and single tube 18 central to cable 1 constituting the central layer).

Each of the spreader parts is provided with guideways to urge each tube towards a particular hole. As illustrated by FIG. 3b, the guideways are formed by a number of continuous walls provided on the spreader, the space between two walls defining a channel slightly wider than an individual tube.

Once the sheath of cable 1 has been stripped to reveal individual tubes, outer spreader part 5a is inserted between the outer tube layer 15 and intermediate tube layer 16. The twelve individual tubes of the outer layer are guided along the guideways into the twelve equidistant holes in outer spreader part 5a. Outer spreader part 5a is pushed down the tubes to a set distance from the multi-tube cable sheath butt 11. A keyway 12 can be provided to align outer spreader part 5a with gland body 4a if necessary.

Intermediate spreader part 5b is then inserted between intermediate tube layer 16 and inner tube layer 17. The twelve individual tubes of the intermediate layer are guided along the guideways into the twelve equidistant holes in the intermediate spreader part 5b. Intermediate spreader part 5b is then pushed down the tubes and into outer spreader part 5a. A keyway 13 is provided for alignment of intermediate spreader part 5b into outer spreader part 5a.

Central tube 18 of the multi-tube cable is then inserted into the hole at the centre of inner spreader part 5c. The six individual tubes of the inner layer are guided along the guideways into the remaining six equidistant holes in inner spreader part 5c. Inner spreader part 5c is then pushed down the tubes and into intermediate spreader part 5b. A keyway 14 is provided for alignment of inner spreader part 5c into intermediate spreader part 5b.

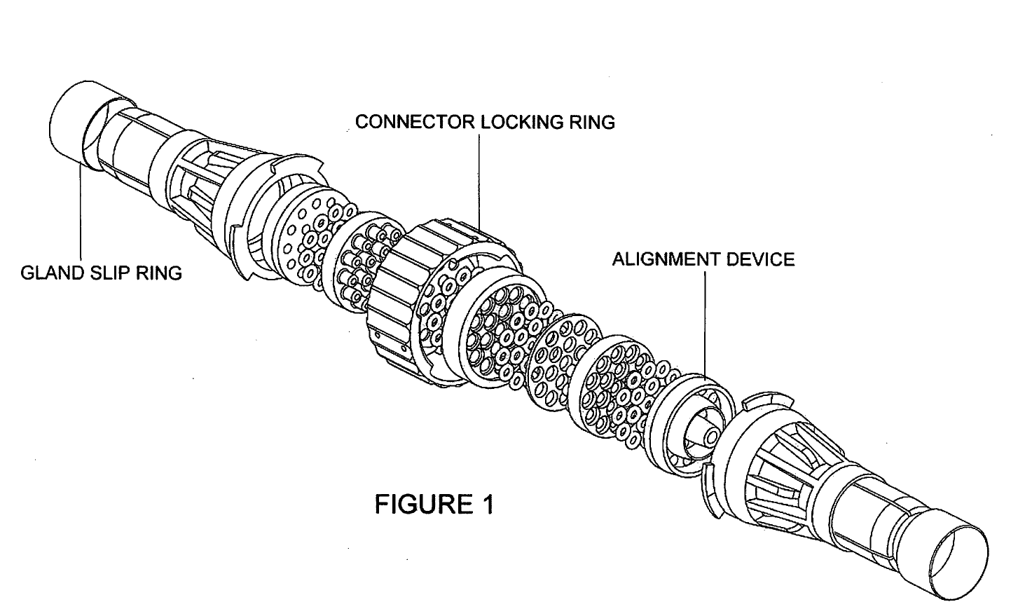

The stepping of the insertion of tubes allows for easier insertion as compared with the alignment device of FIG. 1. The alignment device requires all tubes to be entered simultaneously, whereas the spreader allows for the tubes to be entered layer by layer.

If required, the spreader can be used to enable improved gas blocking. The tubes are presented such that when a gas blocking material is inserted, it is able to spread evenly through the tube interstices to ensure an effective gas block.

Although the example in FIG. 3b comprises three spreader parts, the number of spreader parts required would depend upon the number of tube layers, which would be determined by the tube count of the cable.

Different sizes of spreader, providing different degrees of splaying, could be used dependant upon the use required. For example, if the spreader is required to be used only as a gas block, a smaller size, which fits into the gland body, could be used (as illustrated in FIGS. B6a-c of the second embodiment, discussed below). However, if the spreader is to connect with a patch tube interface, a greater degree of splaying, and therefore a larger spreader, may be required.

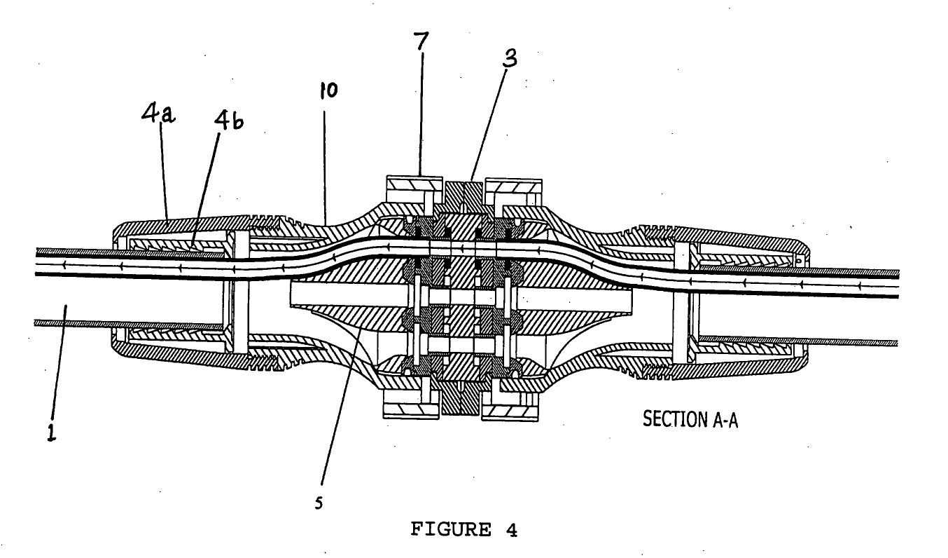

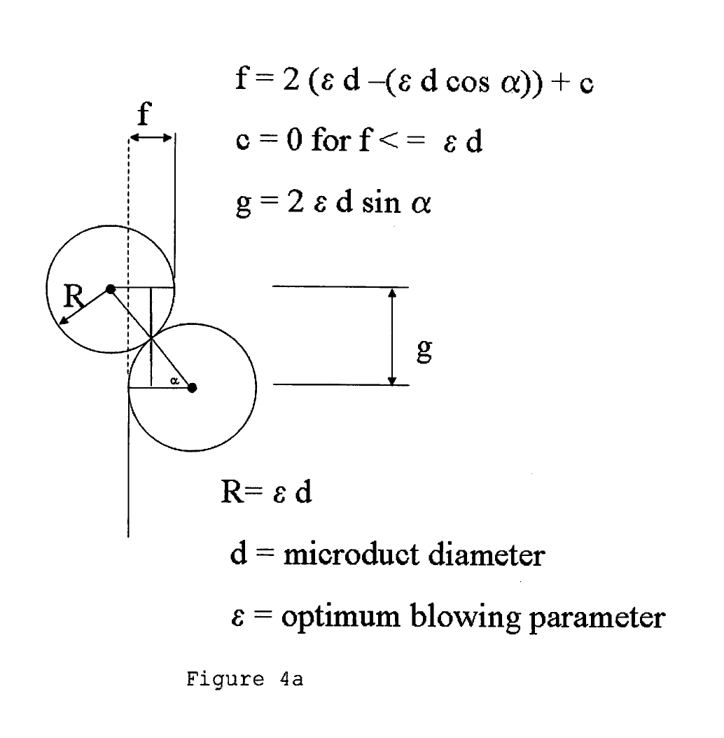

FIG. 4 shows the route of a single tube through the system. Cable gripping gland 4 and spreader 5 are formed such that all tubes except the central tube assume an ‘S’ bend, which ensures that the end of a tube is parallel to the same tube when in the bundle clamped by cable gripping gland 4.

FIG. 4a provides a formulaic representation of shape required to be formed by the tube to allow an optical fibre to be installed by the blown fibre method. The formula provides the displacement of the tube from its original position, and the subsequent distance between the beginning and end of the bend in the connector, using the centre line of the tube as a reference point.

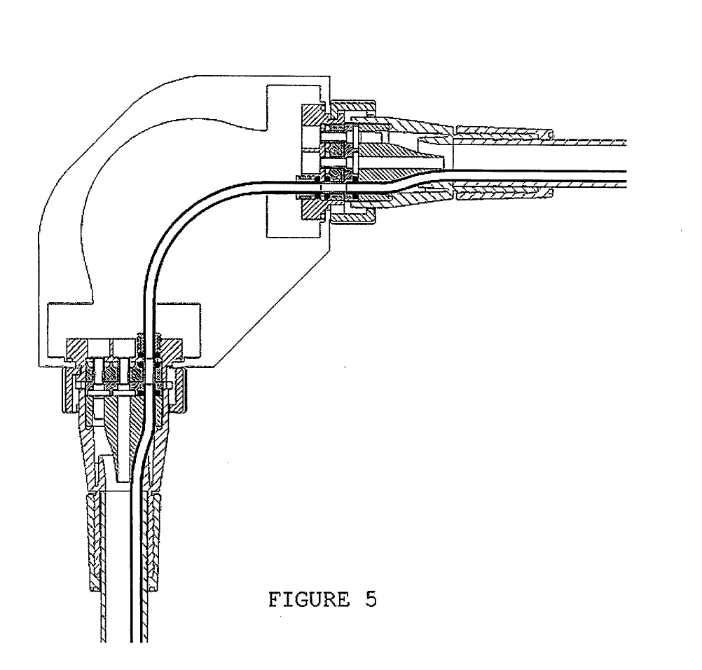

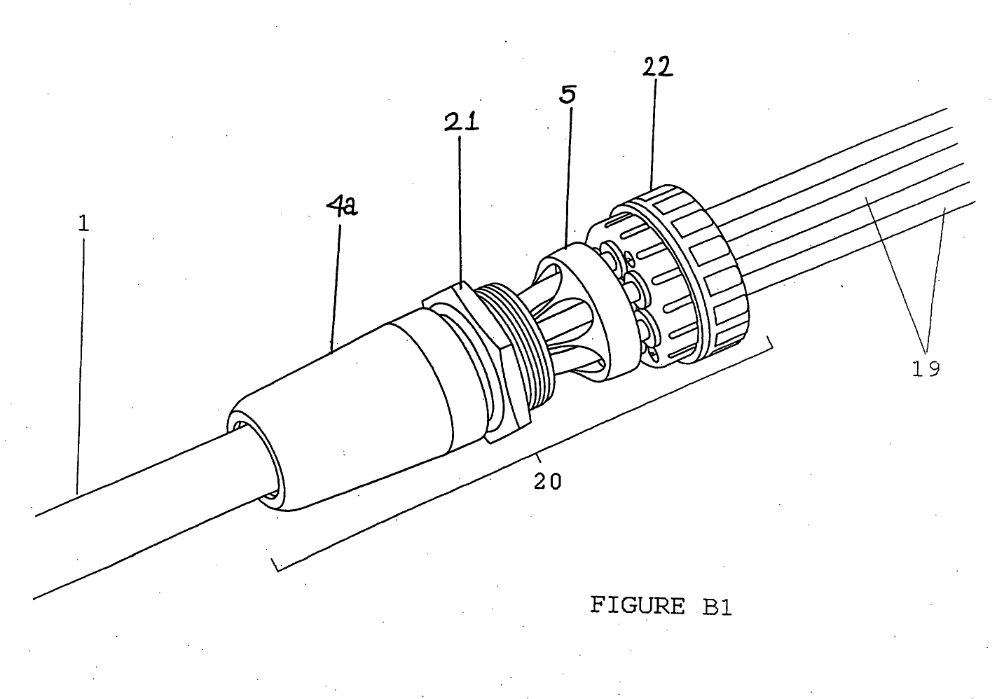

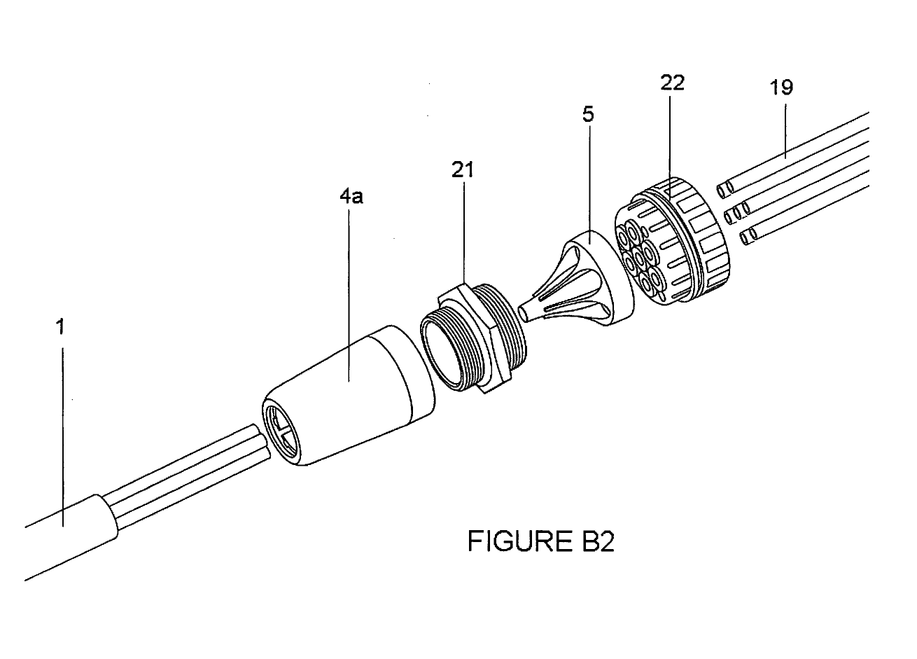

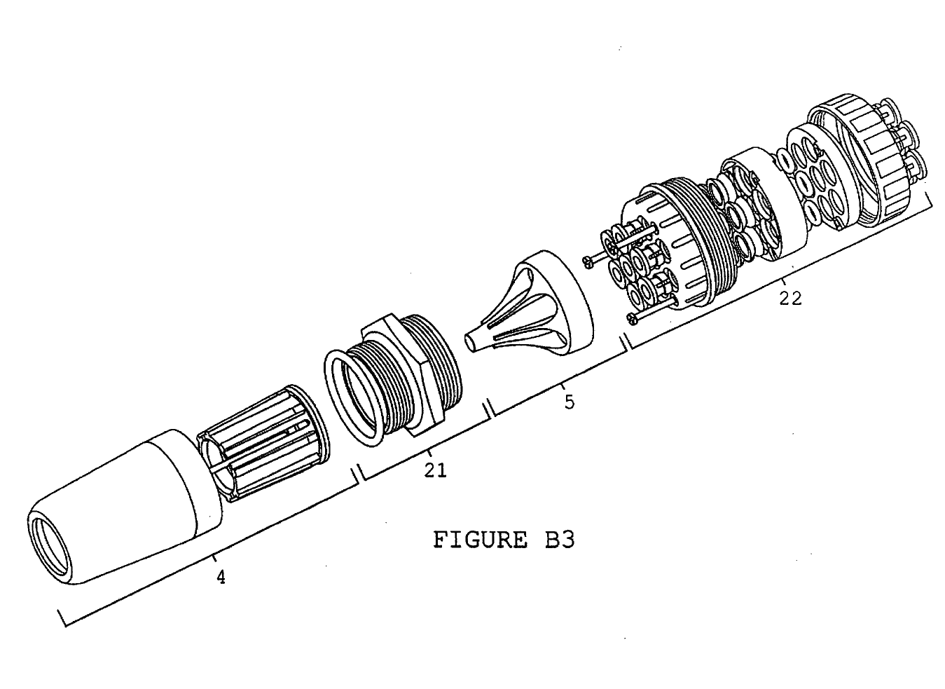

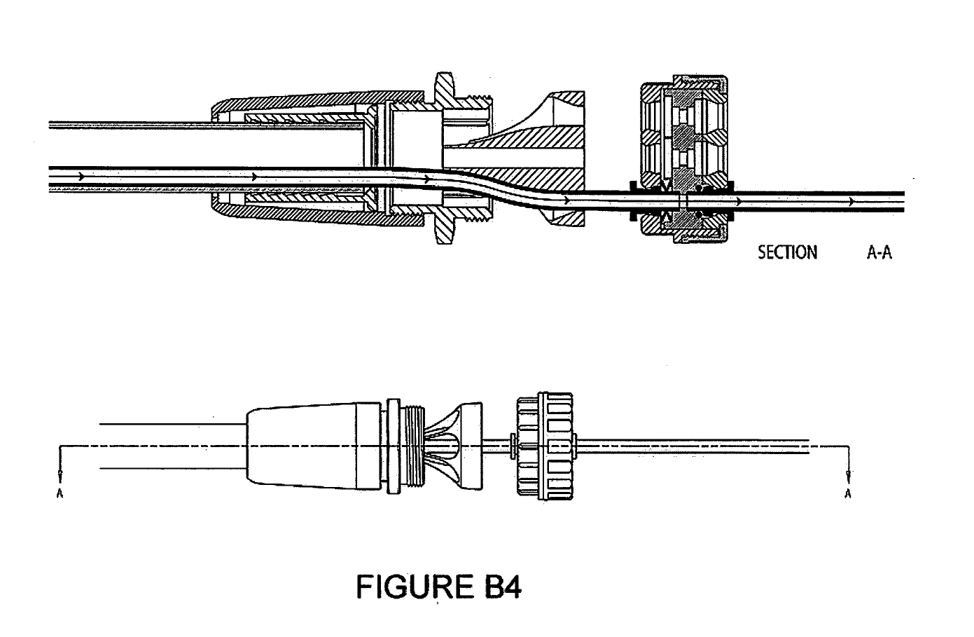

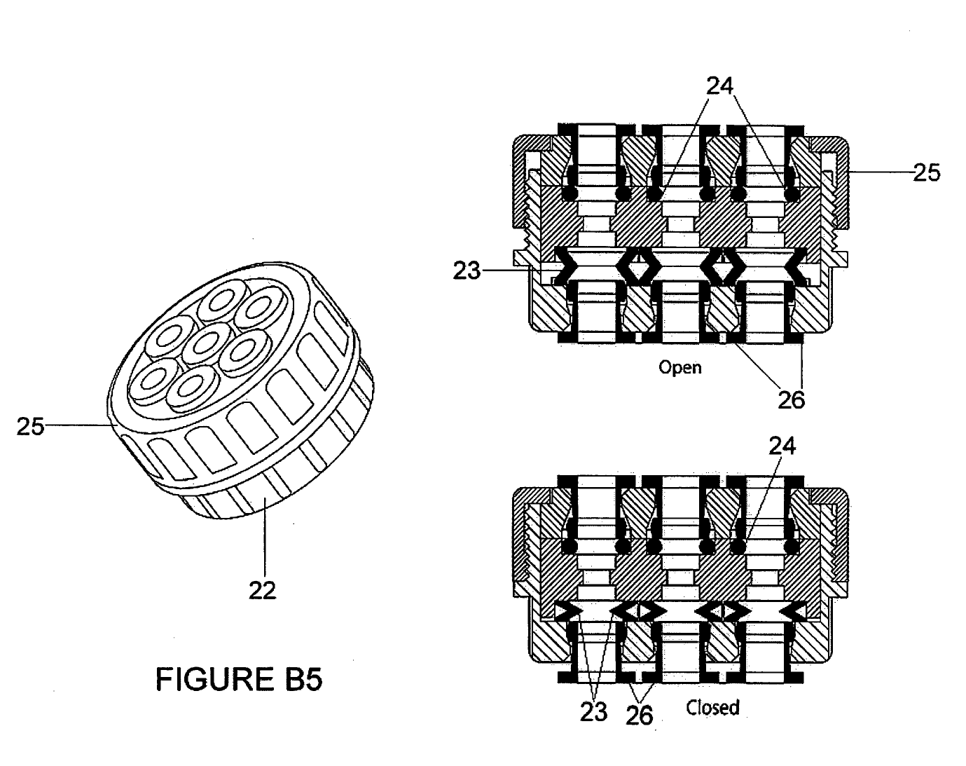

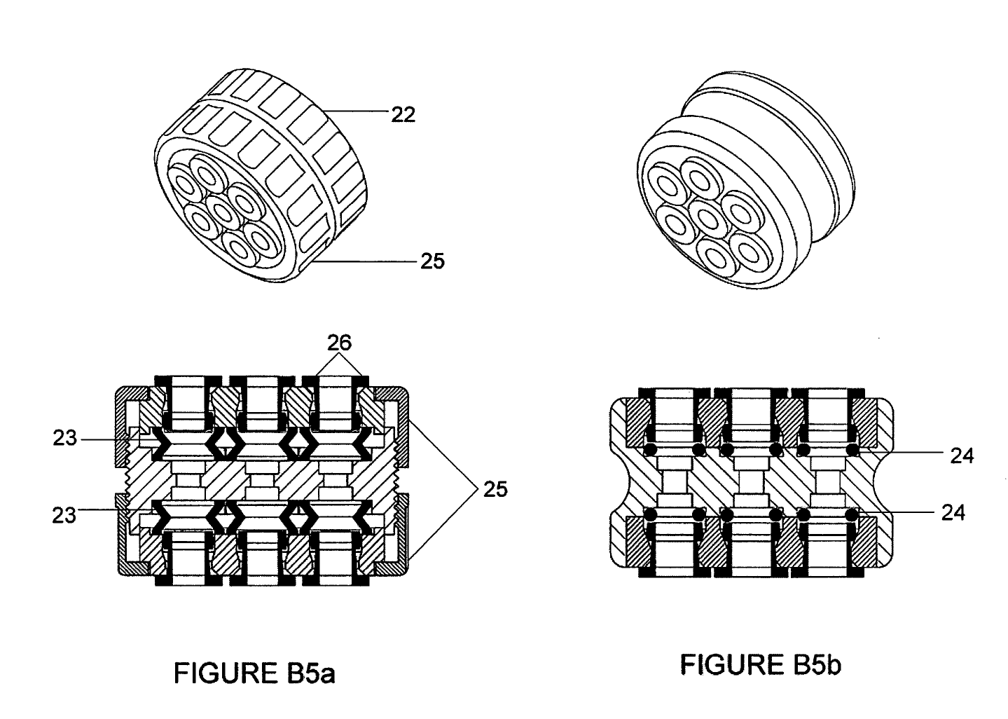

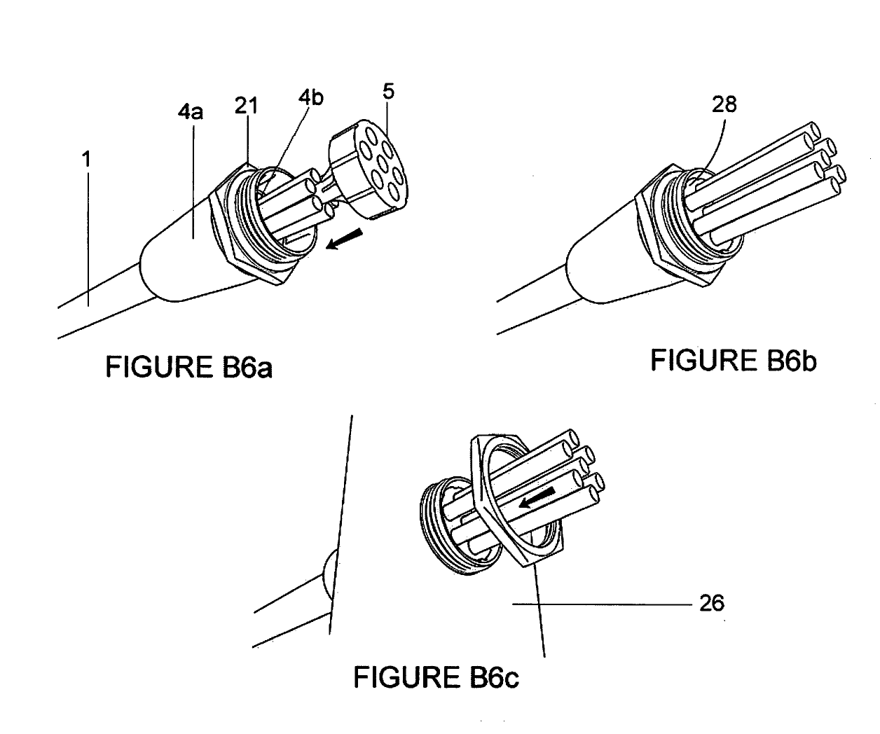

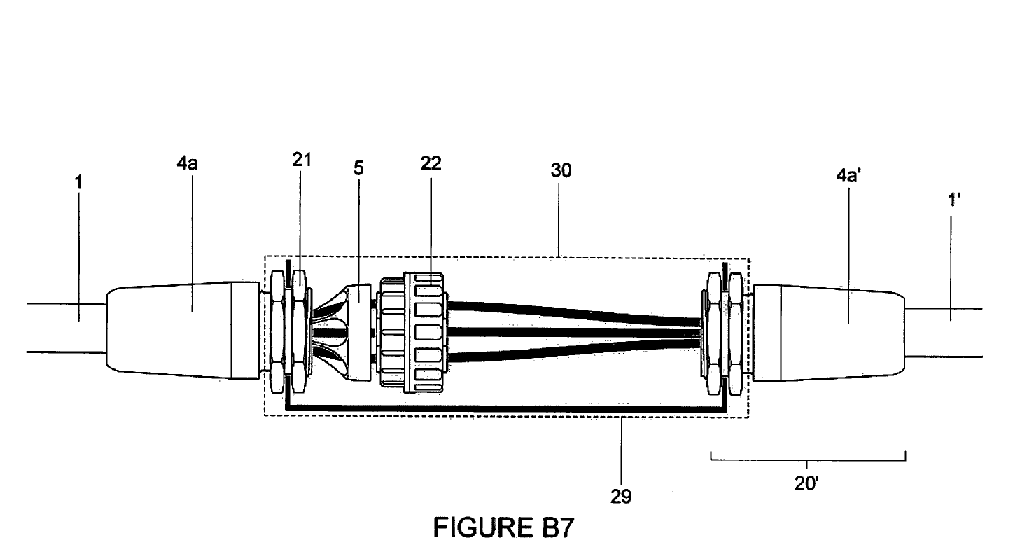

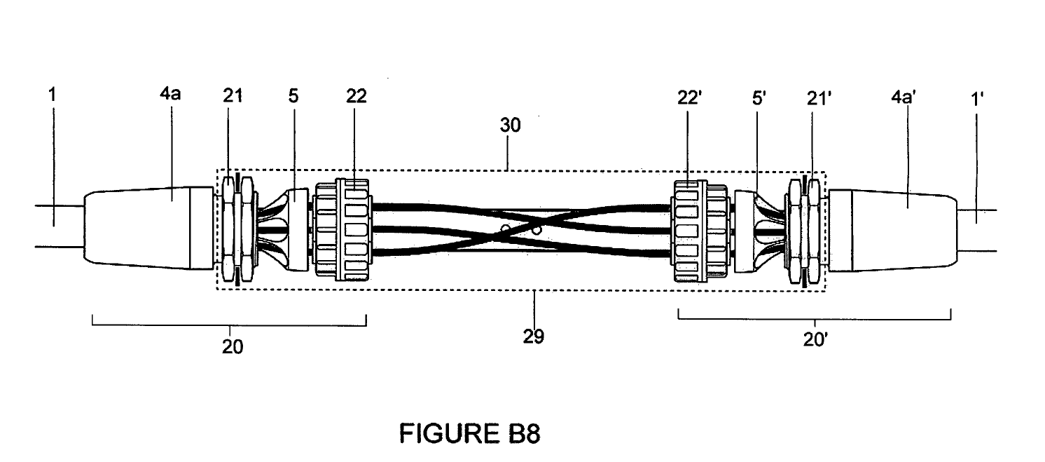

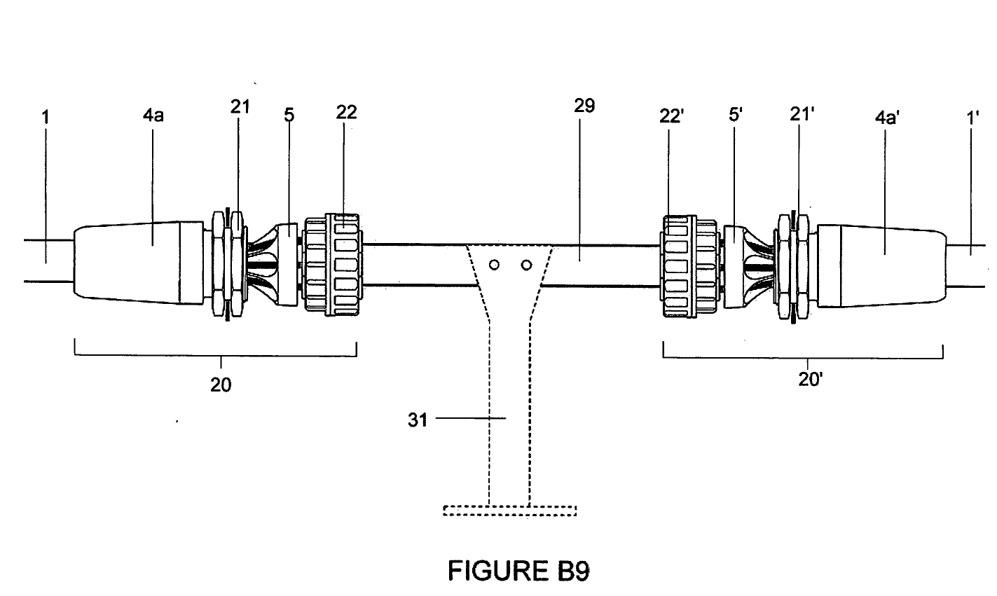

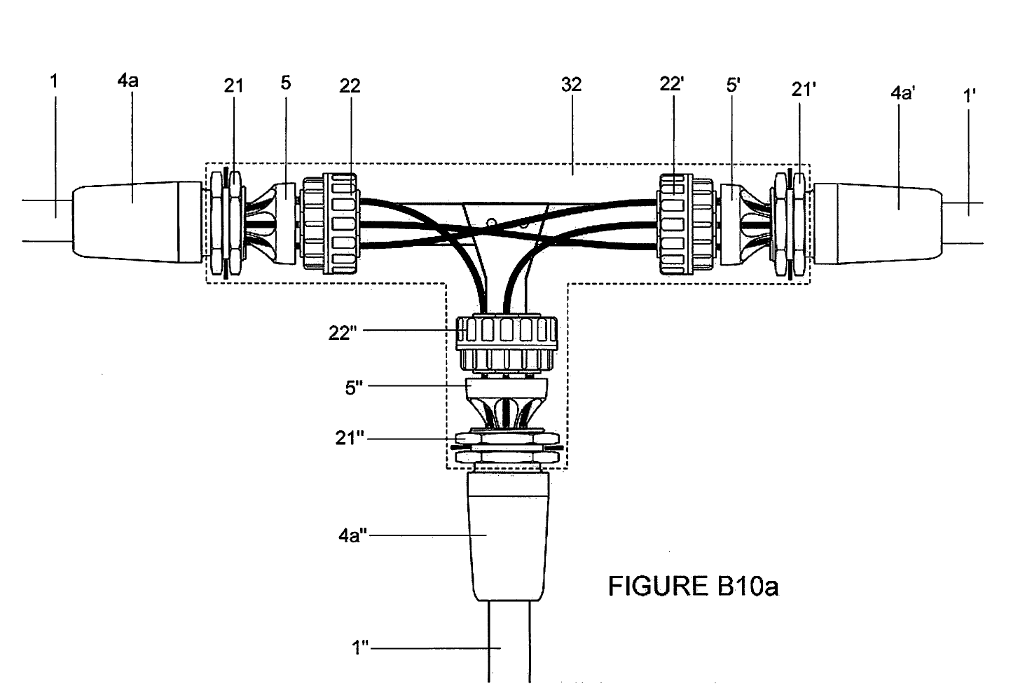

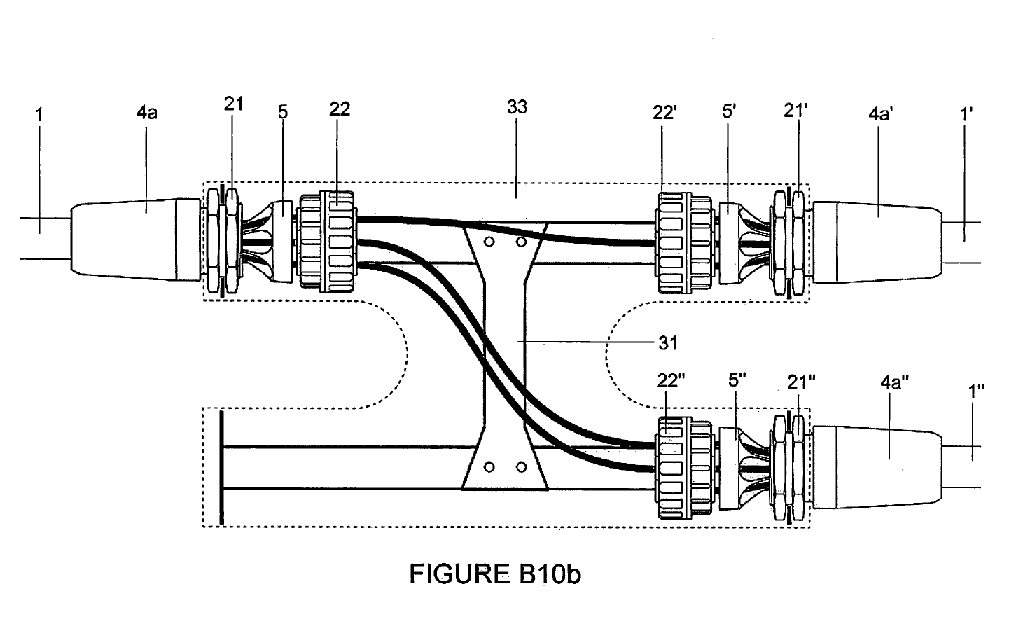

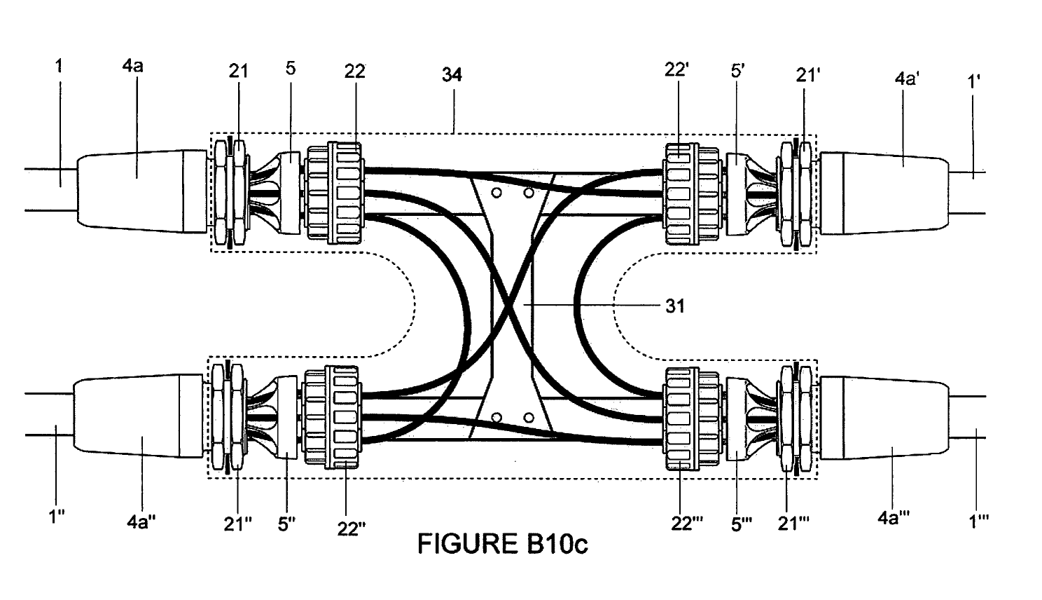

It may be possible for substitution of the connecting part 3 for to occur after installation of the tubes and prior to blown installation of the fibre. The connecting part 3 may also be formed in a particular configuration to provide a certain function, such as a spacer. FIG. 5 shows the connector part formed into an elbow, and illustrates the path of a single tube through the connector. This configuration can be used when it is necessary to change the direction of the optical fibre cables, for example, to turn a corner. To prevent tube kink or tube collapse, a minimum bend radius must be maintained for multi-tube cables on changing direction. The minimum bend radius for multi-tube cables is approximately ten times the diameter of the cable, e.g. a multi-tube cable comprising seven 5 mm tubes and having an overall diameter of 20 mm should not be subjected to a bend of less than 200 mm. However, by stripping the sheath from the cable and essentially treating each single 5 mm tube as a separate entity, the minimum bend radius is reduced to 50 mm. The elbow contains pre-configured routes for the tubes at the correct radii, and provides a patch tube interface which allows a fibre optic multi-tube gland and multi-tube cable to be connected to either end. Therefore the space required to achieve the 90° bend is reduced compared with bending the cable as a whole.

The gland system will now be described in accordance with the accompanying FIGS. B1 to B10.

FIG. B1 shows a cable of tubes 1 connected with single tubes 19 via fibre multi-tube gland system 20. As illustrated, bare tubes are exposed between the component parts of the optical fibre multi-tube gland system.

As illustrated in FIGS. B2 and B3, the optical fibre multi-tube gland system comprises cable gripping gland 4, enclosure interface 21, spreader 5, and patch tube interface assembly 22. (The cable gripping gland and spreader are of the same type disclosed above for the first embodiment.)

Cable 1 is split into individual tubes within cable gripping gland 4 and enclosure interface 21, with sealing means 8 provided between cable gripping gland 4 and enclosure interface 21. The tubes are splayed by spreader 5 and then pass through patch tube interface assembly 22. The connection is completed by tubes 19 which are connecting patch tubes, or tubes from a second optical fibre multi-tube gland system.

The cross section A-A of FIG. B4 shows the route of a single tube through the optical fibre multi-tube gland system. As illustrated, the enclosure interface 21 and spreader 5 act so as to form an ‘S’ bend in the tubes, as described for the first embodiment.

FIG. B5 provides detail of patch tube interface assembly 22. Deformable ‘V’ rings 23 are provided at one interface and conventional ‘O’ rings 24 at the second interface. ‘V’ rings 23 allow relatively easy manual insertion of multiple individual tubes simultaneously into patch tube interface assembly 22. (Due to the force required to introduce a tube into an ‘O’ ring, manual simultaneous insertion of multiple tubes would be difficult without the use of a specialist tool.)

After insertion of the tubes into the patch tube interface assembly 22, screw cap 25 is tightened to compress each of the ‘V’ rings 23 onto the individual tubes to form a seal. Conventional ‘O’ rings 24 are used to form a seal around the individual tubes on the second interface. The action of tightening screw cap 25 also ensures that the ends of the tubes remain butted against the main body of patch tube interface assembly 22 by forcing collets 26 away from patch tube interface assembly 22 thereby stopping movement of the individual tubes. FIG. B5 shows patch tube interface assembly 22 in both an open position, i.e. when the ‘V’ rings 23 are in a relaxed state, and a closed position, i.e. after the screw cap 25 has been tightened.

Collets 26 may be fitted with coloured ‘C’ clips to provide a colour key for alignment of tubes.

FIG. B5a shows a patch tube interface assembly 22 with deformable ‘V’ rings 23 at both interfaces, thus allowing for simultaneous manual insertion of multiple tube inputs or single tube inputs (e.g. one tube at a time) from both directions prior to tightening screw cap 25.

Figure c shows a patch tube interface assembly 22 with conventional ‘O’ rings 24 at both interfaces. The functionality of screw cap 25 of FIGS. B5 and B5a may not be required for this version.

The choice of configuration of seal types (i.e. as in FIG. B5a or B5b or a combination thereof) would be determined by the intended purpose which the patch tube interface assembly.

FIG. B6 shows the optical fibre multi-tube gland system being used to terminate a multi-tube cable at an interface 27 using gland body 4a, cable adapter 4b, spreader 5. Interface 27 could be, for example, a bulkhead, an enclosure, or a metal plate. Spreader 5 splays the tubes in the same way as the spreader in FIG. 3b of the first embodiment, thus enabling gas blocking material to be inserted around the interstices. In this embodiment, the spreader is small enough to fit into gland body 4a such that a gas blocking material 28, such as resin, can be inserted so as to cover the spreader, as illustrated in FIGS. B6b and B6c.

As illustrated in FIGS. B7 to B10, the system may also include a chassis for supporting a plurality of system components, allowing the termination of a plurality of multi-tube cables without the need to remove the original multi-tube cables from the chassis, thereby protecting any ‘live’ path between the multi-tube cables. The ability to fully remove the enclosure from the chassis allows access to the tubes between the multi-tube cables, without taking valuable space when closed.

FIG. B7 shows the optical fibre multi-tube gland system being used as a simple in-line join between two multi-tube cables, 1 and 1′. This join would provide limited opportunity for future upgrade or tube reconfiguration. A chassis 29, of for example a metallic material, is used to support the components.

The optical fibre multi-tube gland system 20 of FIG. B7 uses the individual tubes from the second multi-tube cable 1′ to complete the connection. Once configuration is complete a two-part enclosure 30 (illustrated by a dotted line) is provided to protect the components. Simple removal of the two-part enclosure 30 allows access to the individual tubes.

FIG. B8 shows an in-line joint which has been further enhanced to provide an easily upgradeable and reconfigurable multi-tube cable joint by using a pair of optical fibre multi-tube gland systems 20 and 20′, and patch tube interface assemblies 22 and 22′. This allows reconfigurable single patch tubes to be used to form the path between the two multi-tube cables. The components are supported by chassis 29, and enclosed by two-part enclosure 30. The original two-part enclosure can be replaced with different versions designed to accept the additional multi-tube cables.

FIG. B9 shows an in-line joint upgraded to a T configuration. Once the two-parts of the enclosure have been removed to gain access to the joint, the components remaining fixed to the chassis, it is possible to adapt the joint to a different configuration. Once a chassis extension piece 31 is added to the existing chassis 29, a further optical fibre multi-tube gland system using a further patch tube interface assembly can be added to the chassis extension piece 31. The required empty patch tubes (prior to optical fibre installation) can now be removed and re-routed to the new multi-tube cable.

FIG. B10a is an example of the tube routing for a T configuration, with a two-part ‘T’ enclosure 32 (illustrated by a dotted line) provided to protect the contents of the joint.

FIGS. B10b and B10c illustrate tube routing for a joints with three and four multi-tube cables respectively, creating ‘Y’ and ‘H’ configurations. In each case, an in-line joint has been reconfigured to accept further multi-tube cables by the addition of chassis extension 31 and appropriate alternative two-part enclosures (33 and 34 respectively, illustrated by dotted lines).

The combination of chassis and enclosure allows 360° access to the joint when required. As the enclosure is close-fitting, it will take up less space than previous multi-tube joint enclosures.

1-21. (canceled)

21. A blown optical fibre multi-tube terminal connector, comprising:
a first part arranged to receive and fit onto a cable of tubes in an initially closely packed state; and
a spreader provided with guideways to splay the tubes received by the first part from an initially closely packed state to a spaced relationship, where the spacing is greater than the spacing at the initially closely packed state;
the arrangement being such that provision is made to connect the connector to at least one further element, including a connecting part with axially aligned sealing provided between the first part and connecting part, and the arrangement being such that provision is made so as to maintain said connector, connecting part, and further element in position relative to one another.

22. A blown optical fibre multi-tube terminal connector as claimed in claim 21 including at least two spreaders, structured to be assembled over the tubes in series.

23. A blown optical fibre multi-tube terminal connector as claimed in claims 21 or 22 wherein a spreader is provided with one guideway for each tube and the guideways are structured to splay the tubes into a generally annular, although not necessarily circular, spaced relationship.

24. A blown optical fibre multi-tube terminal connector as claimed in claim 22 wherein the spreaders comprise at least two interconnecting and telescoping parts providing generally annular, although not necessarily circular, splay patterns.

25. A blown optical fibre multi-tube terminal connector, as claimed in 21, wherein the provision so as to connect the connector to at least one further element is made by a connecting part including at least one locking ring.

26. A blown optical fibre multi-tube terminal connector as claimed in claim 21 wherein at least two said first parts are linked by at least one said connecting part.

27. A blown optical fibre multi-tube terminal connector as claimed in claim or 21 wherein axially aligned sealing is provided between the connecting part and a further element.

28. A blown optical fibre multi-tube terminal connector as claimed in claim or 21 wherein the connecting part is formed as an assembly arranged so that individual tubes from the connector can be connected with further tubes, said assembly having at least two sets of multiple entries, each set of multiple entries having a set of axially aligned seals.

29. A blown optical fibre multi-tube terminal connector as claimed in claim 28 wherein at least one set of axially aligned seals comprises ‘O’ rings.

30. A blown optical fibre multi-tube terminal connector as claimed in claim 28 wherein at least one set of axially aligned seals comprises seals which at a relaxed state have a minimum internal diameter not less than the diameter of one of the entries.

31. A blown optical fibre multi-tube terminal connector as claimed in claim 21 wherein an enclosure interface assembly with axially aligned sealing is provided between the first part and the spreader.

32. A blown optical fibre multi-tube terminal connector as claimed in claim 21 wherein provision in made so as to surround the spreaders in their entirety by a gas blocking material.

33. A blown optical fibre multi-tube terminal connector as claimed in claim 21 wherein a supporting chassis is provided to maintain the components of the connector in a constant position relative to one another.

34. A blown optical fibre multi-tube terminal connector comprising a first part arranged to receive and fit onto a cable of tubes in an initially closely packed state, and a spreader provided with guideways to splay the tubes received by the first part from an initially closely packed state to a spaced relationship where the spacing is greater than the spacing at the initially closely packed state, the arrangement being such that provision is made so as to connect the connector to at least one further element, and wherein an extendable supporting chassis is provided to maintain the components of the connector in a constant position relative to one another while allowing for connection of the connector to further multi-tube cables.

35. A blown optical fibre multi-tube terminal connector as claimed in claims 21 or 34 wherein a removable enclosure of at least two parts is provided to protectably surround the blown optical fibre multi-tube terminal connector.

36. A blown optical fibre multi-tube terminal connector, as claimed in claim 21 wherein the connecting part is provided with pre-configured individual tube routes.

37. A blown optical fibre multi-tube terminal connector as claimed in claims 21 or 34 having alignment means such that the position of an individual tube relative to other tubes can be identified.

38. A blown optical fibre multi-tube terminal connector as claimed in claims 21 or 34 wherein the ends of the tubes are arranged in a linear plane normal to an axial centre of the connector.

39. A blown optical fibre multi-tube terminal connector for connecting tubes to at least one further element during fibre optic communication, comprising:
a first part arranged to receive and fit onto a cable of tubes in an initially closely packed state; and
a spreader provided with carved guideways to splay the tubes received by the first part from an initially closely packed state to a spaced relationship where the spacing is greater than the spacing at the initially closely packed state;
the arrangement being such that provision is made so as to connect the connector to the at least one further element; and
wherein the tubes form a planar ‘S’ bend within the connector and such that the ends of tubes in spaced relationship are parallel to the same tube in the closely packed state received in the first part.

40. A method for connecting multi-blown optical fibre tubes to at least one further element for use during fibre optic communication, comprising:
arranging a first part to receive and fit onto a cable of tubes in an initially closely packed state;
splaying the tubes by assembling a spreader provided with guideways to splay the tubes received by the first part from an initially closely packed state to a spaced relationship where the spacing is greater than the spacing at the initially closely packed state;
providing an arrangement so as to connect the connector to the at least one further element; and
providing a connecting part with axially aligned sealing between the first part and connecting part so as to maintain said connector, connecting part and further element in position relative to one another.

41. A method for connecting multi-blown fiber optic tubes to at least one further element for use during fibre optic communication, comprising:
arranging a first part to receive and fit onto a cable of tubes in an initially closely packed state;
splaying the tubes by assembling at least two spreaders, in series, the spreaders provided with guideways to splay the tubes received by the first part from an initially closely packed state to a spaced relationship where the spacing is greater than the spacing at the initially closely packed state; and
providing an arrangement so as to connect the connector to the at least one further element.

42. A method for connecting multi-blown optical fibre tubes to at least one further element for use during fibre optic communication, comprising:
arranging a first part to receive and fit onto a cable of tubes in an initially closely packed state;
splaying the tubes by assembling a spreader provided with guideways to splay the tubes received by the first part from an initially closely packed state to a spaced relationship where the spacing is greater than the spacing at the initially closely packed state;
forming the tubes in a planar ‘S’ bend within the connector such that the ends of tubes in spaced relationship are parallel to the same tube in the closely packed state received in the first part; and
providing an arrangement so as to connect the connector to the at least one further element.
